(19) United States
(12) Patent Application Publication
(10) Pub. No.: US 2025/0074253 A1
(43) Pub. Date: Mar. 6, 2025

(54) POWER SUPPLY DEVICE

(71) Applicant: BYD COMPANY LIMITED, SHENZHEN (CN)

(72) Inventors: Ke ZHANG, Shenzhen (CN); Rongfang WU, Shenzhen (CN); Xi WANG, Shenzhen (CN); Zizhu GUO, Shenzhen (CN); Yi PAN, Shenzhen (CN)

(21) Appl. No.: 18/951,271

(22) Filed: Nov. 18, 2024

Related U.S. Application Data
(63) Continuation of application No. PCT/CN2023/082700, filed on Mar. 21, 2023.

(30) Foreign Application Priority Data
May 31, 2022 (CN) 202210610453.0

(51) Int. Cl. B60L 58/18; H01M 10/052; H01M 10/42; H01M 10/44; H01M 10/48; H02J 7/00; H02J 7/34

(52) U.S. Cl. CPC B60L 58/18; H01M 10/052; H01M 10/425; H01M 10/441; H01M 10/482; H02J 7/0063; H02J 7/00712; H02J 7/342; H01M 2220/20

(57) ABSTRACT

A power supply device includes a first and a second battery cell. A ratio of first parameters of the first battery cell to the second battery cell is greater than a first threshold. A ratio of second parameters of the second battery cell to the first battery cell is greater than a second threshold. When a capacity of the first battery cell is greater than that of the second battery cell, the first battery cell and/or the second battery cell are/is discharged according to a rule including a first, a second, and a third condition. When the first condition is satisfied, the first battery cell is discharged to a load. When the second condition is satisfied, the first battery cell and the second battery cell are discharged to the load. When the third condition is satisfied, the first battery cell is discharged to the second battery cell and the load.

### CROSS-REFERENCE TO RELATED APPLICATIONS

This application is a continuation application of International Patent Application No. PCT/CN2023/082700, filed on Mar. 21, 2023, which is based on and claims priority to and benefits of Chinese Patent Application No. 202210610453.0, filed on May 31, 2022. The entire content of all of the above-referenced applications is incorporated herein by reference.

### FIELD

This present disclosure relates to the field of battery technologies, and particularly, to a power supply device.

### BACKGROUND

Currently, a lithium ion battery is the most widely used energy storage device in the field of new energy vehicles. In an electric vehicle, generally, hundreds of battery cells are connected in a serial or parallel manner to form a battery module or a power supply device, and are combined with management systems, such as a battery management system (BMS) and a thermal management system (TMS), to provide output under different working conditions for the electric vehicle.

In the related art, the electric vehicle requires the power supply device to have significantly different output capabilities under the different working conditions. However, an inner part of the power supply device is generally formed by a single type of battery cells. In addition, battery core sizes, mass energy densities, volume energy densities, power densities, and the like of this type of battery cells are often the same or similar. As a result, the current power supply device cannot satisfy an output requirement of the electric vehicle under the different working conditions.

### SUMMARY

The present disclosure resolves a problem that an existing power supply device cannot satisfy an output requirement of an electric vehicle under different working conditions, by providing a method for controlling a power supply device.

To resolve the foregoing technical problem, the present disclosure provides a power supply device. The power supply device includes a first battery cell and a second battery cell. A ratio of a first parameter of the first battery cell to a first parameter of the second battery cell is greater than a first preset threshold, a ratio of a second parameter of the second battery cell to a second parameter of the first battery cell is greater than a second preset threshold, and the first preset threshold and the second preset threshold are greater than 1; and

in response to a determination that a capacity of the first battery cell is greater than a capacity of the second battery cell, the first battery cell and/or the second battery cell are/is discharged according to a rule.

The rule includes a first condition, a second condition, and a third condition.

In response to a determination that the first condition is satisfied, the first battery cell is discharged to a load;

in response to a determination that the second condition is satisfied, the first battery cell and the second battery cell are discharged to the load; and

in response to a determination that the third condition is satisfied, the first battery cell is discharged to charge the second battery cell and discharged to the load.

In an example disclosed by the present disclosure, the first threshold and the second threshold are greater than or equal to 1.5.

In an example disclosed by the present disclosure, the first battery cell includes at least one first battery core, and the second battery cell includes at least one second battery core. The at least one first battery core and the at least one second battery core satisfy |V1−V2|>0.1*V1 or |V1−V2|>0.1*V2.

A voltage of the at least one first battery core is V1, and a voltage of the at least one second battery core is V2.

In an example disclosed by the present disclosure, the first battery cell includes multiple first battery cores, the multiple first battery cores are of a first chemical system, the second battery cell includes multiple second battery cores, the multiple second battery cores are of a second chemical system, and the first chemical system and the second chemical system are different.

In an example disclosed by the present disclosure, the first battery cell is a lithium iron phosphate battery, and the second battery cell is a lithium manganese oxide battery.

In an example disclosed by the present disclosure, the first battery cell is a lithium iron phosphate-graphite battery, and the second battery cell is a lithium metal battery.

In an example disclosed by the present disclosure, the power supply device further includes a control circuit. Both the first battery cell and the second battery cell are connected to the control circuit. The power supply device further includes a controller. The controller is connected to the control circuit, and configured to control the first battery cell and the second battery cell to discharge according to the rule through the control circuit.

In an example disclosed by the present disclosure, the control circuit includes a first switch transistor, a second switch transistor, and a first inductance.

A first positive output terminal of the first battery cell is connected to a second negative output terminal of the second battery cell, a first negative output terminal of the first battery cell is connected to a first terminal of the first switch transistor and a load negative terminal of the load, a second positive output terminal of the second battery cell is connected to a second terminal of the second switch transistor and a load positive terminal of the load, an terminal of the first inductance is connected to the first positive output terminal and the second negative output terminal, and another terminal of the first inductance is connected to a second terminal of the first switch transistor and a first terminal of the second switch transistor.

In an example disclosed by the present disclosure, in response to the determination that the first condition is satisfied, the first battery cell discharged to the load comprises: the controller controls on-duty cycles of the first switch transistor and the second switch transistor, and controls a voltage difference between the second positive output terminal of the second battery cell and the second terminal of the second switch transistor to be within a first range, for the first battery cell to discharge to the load;

in response to the determination that the second condition is satisfied, the first battery cell and the second battery cell discharged to the load comprises: the controller controls the first switch transistor and the second switch transistor to be turned off, for the first battery cell and the second battery cell to discharge to the load;

in response to the determination that the third condition is satisfied, the first battery cell discharged to charge the second battery cell and discharged to the load comprises: the controller controls on-duty cycles of the first switch transistor and the second switch transistor, and controls a voltage difference between the second positive output terminal of the second battery cell and the second terminal of the second switch transistor to be within a second range, for the first battery cell to discharge to charge the second battery cell and discharge to the load; and

a maximum value of the first range is less than a minimum value of the second preset range.

In an example disclosed by the present disclosure, the power supply device includes multiple battery cells. One of the multiple battery cells is the first battery cell, and the rest of the multiple battery cells are the second battery cells; or one of the multiple battery cells is the second battery cell, and the rest of the multiple battery cells are the first battery cells;

or some of the multiple battery cells are the first battery cells, and the rest of the multiple battery cells are the second battery cells.

In an example disclosed by the present disclosure, the first parameter of the first battery cell and the first parameter of the second battery cell are respectively a capacity of the first battery cell and a capacity of the second battery cell; and

the second parameter the second parameter of the first battery cell and the second parameter of the second battery cell are respectively a maximum rated pulse discharge rate of the first battery cell and a maximum rated pulse discharge rate of the second battery cell.

In an example disclosed by the present disclosure, the first condition is that a required power of the load is less than a power outputted by the first battery cell at the maximum rated pulse discharge rate of the first battery cell, and/or a state of charge of the first battery cell is greater than a state of charge of the second battery cell and the state of charge of the second battery cell is less than a third threshold;

the second condition is that the required power of the load is greater than the power outputted by the first battery cell at the maximum rated pulse discharge rate of the first battery cell, and/or the state of charge of the first battery cell and the state of charge of the second battery cell are greater than a fourth threshold, and/or the state of charge of the first battery cell and the state of charge of the second battery cell are less than a fifth threshold; and

the third condition is that the state of charge of the first battery cell is greater than the state of charge of the second battery cell, and a difference between the state of charge of the first battery cell and the state of charge of the second battery cell is greater than a sixth threshold.

The maximum rated pulse discharge rate of the first battery cell is a maximum discharge rate causing a voltage of the first battery cell to drop to a cut-off voltage within 10 s, and the maximum rated pulse discharge rate of the second battery cell is a maximum discharge rate causing a voltage of the second battery cell to drop to a cut-off voltage within 10 s.

Beneficial effects according to the present disclosure are as follows. the power supply device includes the first battery cell and the second battery cell. By defining the ratio between the first parameters of the two battery cells to be greater than the first preset threshold, the ratio between the second parameters to be greater than the second preset threshold, and the capacity of the first battery cell to be greater than the capacity of the second battery cell, and by controlling the first battery cell and/or the second battery cell to discharge according to the preset rule, the first battery cell can be externally discharged and discharged together with the second battery cell based on a determination that the second battery cell needs to be introduced, to ensure that the power supply device can satisfy the output requirement of the electric vehicle under the different working conditions, to improve output efficiency of the power supply device.

### BRIEF DESCRIPTION OF THE DRAWINGS

FIG. 1 is a schematic diagram of a power supply device according to an example of the present disclosure; and

FIG. 2 is a circuit diagram of a power supply device according to an example of the present disclosure.

In the drawings:

101: first battery cell; 1011: first positive output terminal; 1012: first negative output terminal; 102: second battery cell; 1021: second positive output terminal; 1022: second negative output terminal; 103: control circuit; 1031: first switch transistor; 10311: first terminal of the first switch transistor; 10312: second terminal of the first switch transistor; 1032: second switch transistor; 10321: first terminal of the second switch transistor; 10322: second terminal of the second switch transistor; 1033: first inductance; 104: load; 1041: load positive terminal; 1042: load negative terminal; and 105: controller.

### DETAILED DESCRIPTION

Examples of the present disclosure are described in detail below, and illustrations of the examples are shown in the drawings, where the same or similar elements or the elements having same or similar functions are denoted by the same or similar reference numerals throughout the description. The examples described below with reference to the drawings are illustrative, and are to explain the present disclosure and cannot be construed as a limitation to the present disclosure.

In the related art, an electric vehicle requires a power supply device to have significantly different output capabilities under different working conditions. However, the power supply device generally includes only a single type of battery cells. Battery core sizes, mass energy densities, volume energy densities, power densities, and the like of this type of battery cells are often the same or similar. As a result, the current power supply device cannot satisfy an output requirement of the electric vehicle under the different working conditions. For example, only power output of about 10 KW to 20 KW is required based on a determination that the electric vehicle travels smoothly. However, power input or output of up to 50 kilowatts to hundreds of kilowatts is generally required based on a determination that the electric vehicle accelerates, decelerates, or recovers braking energy. If the power supply device includes only a single type of battery cores, only that the electric vehicle runs steadily under one working condition can be ensured.

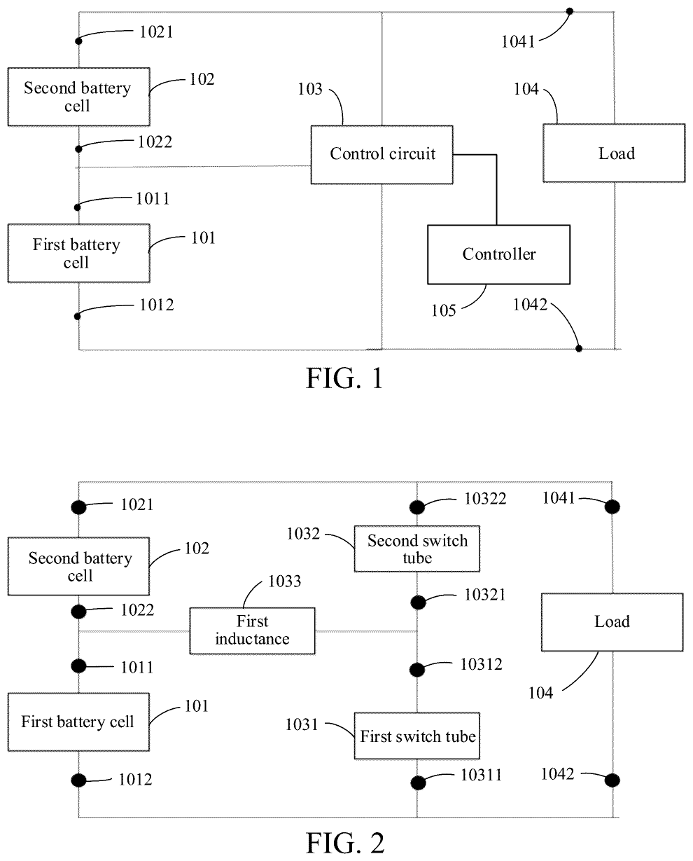

Based on this, a power supply device is disclosed in the examples of the present disclosure. The power supply device is configured to supply power to a load 104. FIG. 1 is a schematic diagram of a power supply device according to an example of the present disclosure. The power supply device includes a first battery cell 101 and a second battery cell 102. A ratio of a first parameter of the first battery cell 101 to a first parameter of the second battery cell 102 is greater than a first preset threshold, a ratio of a second parameter of the second battery cell 102 to a second parameter of the first battery cell 101 is greater than a second preset threshold, and the first preset threshold and the second preset threshold are greater than 1. In an embodiment, the first battery cell 101 has a great advantage in terms of performance corresponding to the first parameter; while the second battery cell 102 has a great advantage in terms of performance corresponding to the second parameter. Based on this, in a vehicle, under a working condition requiring a great advantage in the first parameter, the first battery cell 101 may be selected for external output; and under a working condition requiring a great advantage in the second parameter, the second battery cell 102 may be selected for external output. There is a specified proportional relationship between the two sets of parameters of the first battery cell 101 and the second battery cell 102 in the power supply device, ensuring that the first battery cell 101 and the second battery cell 102 can satisfy an output requirement of the vehicle under different working conditions of the vehicle, to improve adaptability of the power supply device to the working conditions of the vehicle. In addition, the power supply device includes the first battery cell 101 and the second battery cell 102 that have different parameters. Therefore, for multiple power supply devices in the vehicle, a difference between different power supply devices can be greatly reduced, a standardized design of the power supply device can be achieved, and costs of the power supply device can also be greatly reduced.

In this example of the present disclosure, the power supply device is a device, for example, a battery pack, that provides electrical energy to the vehicle or a component such as a controller of the vehicle. The first battery cell 101 and the second battery cell 102 may be battery packs, or may be battery modules. This is not limited in the present disclosure.

In an embodiment of the present disclosure, the first parameter is a capacity, and a ratio of a first capacity of the first battery cell 101 to a second capacity of the second battery cell 102 is greater than the first preset threshold. The second parameter is a maximum rated pulse discharge rate, and a ratio of a maximum rated pulse discharge rate of the second battery cell 102 to a maximum rated pulse discharge rate of the first battery cell 101 is greater than the second preset threshold. The maximum rated pulse discharge rate is a maximum discharge rate causing a voltage of a battery to drop to a cut-off voltage within 10 s. Based on the foregoing parameter definition, the first battery cell 101 is configured to perform main output, to be specific, continuous demand for power of the vehicle is ensured by using an advantage of a large capacity of the first battery cell 101. The second battery cell 102 is configured to, based on a determination that demand of the vehicle for a high power is satisfied, cooperate with the first battery cell to output, to be specific, high-speed and high-energy operation of the vehicle is ensured by using an advantage of a large maximum rated pulse discharge rate of the second battery cell 102.

In another example of the present disclosure, the first parameter may be an energy density, and the second parameter may be a cycle life or a quantity of cycles, to cause the first battery cell 101 to satisfy demand for high-efficiency output of the vehicle, and the second battery cell 102 to satisfy long-range endurance of the vehicle. In another example of the present disclosure, the first parameter may be the capacity, and the second parameter may be a cycle life, to cause the first battery cell 101 to satisfy the continuous demand for power of the vehicle, and the second battery cell 102 to satisfy long-range endurance of the vehicle.

In an example of the present disclosure, based on a determination that a capacity of the first battery cell 101 is greater than a capacity of the second battery cell 102, the first battery cell 101 and/or the second battery cell 102 are discharged according to a preset rule. In an embodiment, the preset rule includes three work modes, as follows.

Work mode 1: Based on a determination that a first preset condition is satisfied, only the first battery cell 101 is discharged to a load 104.

Work mode 2: Based on a determination that a second preset condition is satisfied, the first battery cell 101 and the second battery cell 102 are discharged together, to the load.

Work mode 3: Based on a determination that a third preset condition is satisfied, the first battery cell 101 is discharged to charge the second battery cell 102 and discharged to the load 104.

Based on the foregoing example, for the vehicle, the power supply device is configured to respond to the demand for power of the vehicle. Based on this, the capacity of the first battery cell 101 is required to be greater than the capacity of the second battery cell 102, to cause that the first battery cell 101 can provide power, to satisfy most of the demand for power of the vehicle. Once the vehicle has special demand, such as demand for high speed, low speed, or energy recovery, the vehicle selects to introduce the second battery cell 102 to satisfy the special demand above, thereby satisfying demand of the vehicle under the different working conditions.

The first battery cell 101 and the second battery cell 102 each have their own advantageous characteristics, and the power supply device can select, based on the advantageous characteristics, a corresponding battery cell for output, to satisfy the output requirement of the vehicle under the different working conditions.

Based on a determination that the power supply device is in the work mode 1, the power supply device is discharged to provide power to the load 104 by using only the first battery cell 101. The load 104 may be a component such as a motor, an electronic control, or a controller of the vehicle. The first preset condition is generally normal demand of the vehicle. In other words, compared with the second battery cell 102, the first battery cell 101 having a great advantage in the first parameter can satisfy the normal demand of the vehicle. In an example of the present disclosure, the first preset condition may be that the vehicle is traveling at a normal speed or traveling smoothly. Based on a determination that the first preset condition is satisfied, the vehicle does not need to change the speed of the vehicle or a change in the speed of the vehicle is small. In this case, in the power supply device in the vehicle, only the first battery cell 101 with a large capacity is configured to externally supply power to satisfy the demand for power of the vehicle. In another example of the present disclosure, the first preset condition may further be that based on a determination that the vehicle needs to be powered continuously and normally, the vehicle needs to be continuously powered by the power supply device, and a power supply current remains unchanged or is in a stable stage. In this case, in the power supply device in the vehicle, only the first battery cell 101 with the large capacity is configured to externally supply power to satisfy the demand for power of the vehicle. In other words, under the first preset condition, the vehicle has the highest demand for power in a life cycle. In this case, it is only necessary to ensure that a battery cell with a large capacity can supply power to the vehicle.

In an example of the present disclosure, the first preset condition is that a required power of the load 104 is less than a power outputted by the first battery cell 101 at the maximum rated pulse discharge rate. Under this condition, a required power of the vehicle is less than a discharge power of the first battery cell 101, and the first battery cell 101 can provide power to satisfy the normal demand of the vehicle. In some embodiments, the first preset condition may further be that a state of charge (SOC) of the first battery cell 101 is greater than an SOC of the second battery cell 102, and the SOC of the second battery cell 102 is less than a third preset threshold. Under this condition, the SOC of the second battery cell 102 cannot satisfy an output requirement, so that only the first battery cell 101 is discharged to provide power. The third preset threshold is generally, for example, 30% SOC, optionally 20% SOC. However, because different users have different definition requirements for the SOC, the third preset threshold may be selected according to an actual case. This is not limited in the present disclosure.

Based on a determination that the power supply device is in the work mode 2, in this case, the first battery cell 101 and the second battery cell 102 are discharged together. Generally, the second preset condition is the special demand of the vehicle. In other words, compared with the first battery cell 101, the second battery cell 102 having a great advantage in the second parameter can satisfy the special demand of the vehicle. For example, in a case that the vehicle accelerates, decelerates, or recovers braking energy, the vehicle not only needs normal power supply, but also needs to satisfy demand under special working conditions such as acceleration and deceleration. Based on this, in the power supply device, the first battery cell 101 the second battery cell 102 are discharged together under the working condition to satisfy the demand for power of the vehicle. In addition, because a ratio of the first parameter of the first battery cell 101 to the second parameter of the first battery cell 101 is different from a ratio of the first parameter of the second battery cell 102 to the second parameter of the second battery cell 102, the second battery cell 102 can satisfy the demand for power based on a determination that the vehicle has the special demand.

In an example of the present disclosure, the second preset condition is that the required power of the load 104 is greater than the power outputted by the first battery cell 101 at the maximum rated pulse discharge rate. Under this condition, because the required power of the vehicle is higher than an output power of the first battery cell 101, only output of the first battery cell 101 cannot satisfy power demand of the vehicle. Based on this, the first battery cell 101 and the second battery cell 102 are configured to output together, to cause the second battery cell 102 to increase an overall output power of the power supply device to satisfy high power demand of the vehicle. In some embodiments, the second preset condition may further be that the SOC of the first battery cell 101 and the SOC of the second battery cell 102 are greater than a fourth preset threshold. Under this condition, it can be ensured that the first battery cell 101 and the second battery cell 102 have enough energy to supply power, so that it can be ensured that the first battery cell 101 and the second battery cell 102 supply power together. The fourth preset threshold is generally 70% SOC, optionally 80% SOC. However, because different users have different definition requirements for the SOC, the fourth preset threshold may be selected according to an actual case. This is not limited in the present disclosure. In some embodiments, the SOC of the first battery cell 101 and the SOC of the second battery cell 102 are less than a fifth preset threshold. Under this condition, the first battery cell 101 and the second battery cell 102 cannot supply power alone. In this case, the first battery cell 101 and the second battery cell 102 are configured to output together. The fifth preset threshold is generally 30% SOC. However, because different users have different definition requirements for the SOC, the fifth preset threshold may be selected according to an actual case. This is not limited in the present disclosure.

Based on a determination that the power supply device is in the work mode 3, in this case, the first battery cell 101 charges the second battery cell 102 and is discharged to the load 104. In this work mode, based on a determination that the third preset condition is generally that the SOC of the first battery cell 101 and the SOC of the second battery cell 102 greatly differ and need to be balanced, the first battery cell 101 with a large capacity is used to charge the second battery cell 102, to achieve balance between batteries. In addition, in this work mode, the first battery cell 101 may still be discharged to the load 104 to satisfy basic demand of the vehicle.

In an example of the present disclosure, the third preset condition is that the SOC of the first battery cell 101 is greater than the SOC of the second battery cell 102, and a difference between the SOC of the first battery cell 101 and the SOC of the second battery cell 102 is greater than a sixth preset threshold. The sixth preset threshold is generally 30% SOC, optionally 50% SOC. However, because different users have different definition requirements for the SOC, the sixth preset threshold may be selected according to an actual case. This is not limited in the present disclosure.

Furthermore, in the examples of the present disclosure, the preset threshold is greater than or equal to 1.5. Based on a determination that the ratio of the first parameter of the first battery cell 101 to the first parameter of the second battery cell 102 and the ratio of the second parameter of the second battery cell 102 to the second parameter of the first battery cell 101 are greater than 1.5 or more, it can be ensured that a large difference exists between the first battery cell 101 and the second battery cell 102, to better satisfy the output requirement of the vehicle under the different working conditions.

In the examples of the present disclosure, the first battery cell 101 includes at least one first battery core, and the second battery cell 102 includes at least one second battery core. The first battery core and the second battery core satisfy |V1−V2|>0.1*V1 or |V1−V2|>0.1*V2. A voltage of the first battery core is V1, and a voltage of the second battery core is V2. Based on the foregoing condition, it can be further ensured that the large difference exists between the first battery cell 101 and the second battery cell 102, to better satisfy the output requirement of the vehicle under the different working conditions. In an embodiment, if a voltage difference between the battery cores in the two battery cells is less than 0.1 times the voltage of the battery core, it indicates that there is no obvious difference in the voltage between the first battery core and the second battery core. The battery cores without obvious difference indicate that the two battery cores have the same capacity. In this case, there is no obvious difference between the first battery cell 101 and the second battery cell 102 that have a same capacity, and the requirement of the vehicle under the different working conditions cannot be satisfied.

In the examples of the present disclosure, the first battery cell 101 includes multiple first battery cores, the multiple first battery cores are of a first chemical system, the second battery cell 102 includes multiple second battery cores, the multiple second battery cores are of a second chemical system, and first chemical system and the second chemical system are different. Based on the foregoing condition, it can be further ensured that the large difference exists between the first battery cell 101 and the second battery cell 102, to better satisfy the output requirement of the vehicle under the different working conditions. In an embodiment, battery cores of different chemical systems have different characteristics, for example, have different capacities or different discharge rates. It is ensured, based on unique characteristics of different chemical systems, that the output requirement of the vehicle under the different working conditions is satisfied. In an example of the present disclosure, a capacity of a lithium iron phosphate battery is generally higher than a capacity of a lithium manganese oxide battery, but a discharge rate of the lithium manganese oxide battery is higher than that of the lithium iron phosphate battery. Based on this, the lithium iron phosphate battery may be used as the first battery cell 101 to continuously supply power, while the lithium manganese oxide battery may be used as the second battery cell 102, to be introduced based on a determination that the vehicle needs high-rate output, to satisfy a requirement such as acceleration that requires high-rate output. In another example of the present disclosure, a cycle life of a lithium iron phosphate-graphite battery is higher than a cycle life of a ternary material-lithium metal battery, but an energy density of the ternary material-lithium metal battery is much higher than that of the lithium iron phosphate-graphite battery. Based on this, the lithium iron phosphate-graphite battery may be used as the first battery cell 101 to efficiently output, while the lithium metal battery may be used as the second battery cell 102, to be introduced based on a determination that the vehicle needs long-range endurance (in other words, based on a determination that the SOC of the first battery cell 101 is low), to satisfy a requirement of endurance mileage.

In the examples of the present disclosure, the first battery cell 101 and the second battery cell 102 are connected in series. In the work mode 2, the first battery cell 101 and the second battery cell 102 are connected in series and discharged together.

In the examples of the present disclosure, the power supply device further includes a control circuit 103. Both the first battery cell 101 and the second battery cell 102 are connected to the control circuit 103, to supply power through the control circuit 103. The power supply device further includes a controller 105. The controller 105 is connected to the control circuit 103, to control, through controlling the control circuit 103, the first battery cell 101 and the second battery cell 102 to discharge according to the preset rule. In an embodiment, as shown in FIG. 1, a first positive output terminal 1011 of the first battery cell 101 is connected to a second negative output terminal 1022 of the second battery cell 102, a first negative output terminal 1012 of the first battery cell 101 is connected to a first terminal of the control circuit 103 and a load negative terminal 1042, a second positive output terminal 1021 of the second battery cell 102 is connected to a second terminal of the control circuit 103 and a load positive terminal 1041, and a third terminal of the control circuit 103 is connected to the first positive output terminal 1011 and the second negative output terminal 1022. In the examples of the present disclosure, the controller 105 controls conduction and on of the control circuit 103 to adjust the work mode of the power supply device. In an embodiment, based on a determination that the first preset condition is satisfied, the controller 105 controls an on-duty cycle of the control circuit 103 and adjust a voltage difference between the second positive output terminal 1021 of the second battery cell 102 and the second terminal of the control circuit 103 to be within a first preset range, thereby ensuring that only the first battery cell 101 outputs. Based on a determination that the second preset condition is satisfied, the controller 105 controls the control circuit 103 to be disconnected, to cause the first battery cell 101 and the second battery cell 102 to be connected in series and output together. Based on a determination that the third preset condition is satisfied, the controller 105 controls an on-duty cycle of the control circuit 103 and adjust a voltage difference between the second positive output terminal 1021 of the second battery cell 102 and the second terminal of the control circuit 103 to be within a second preset range, thereby causing the first battery cell 101 to charge the second battery cell 102 and supply power.

Furthermore, as shown in FIG. 2, The control circuit 103 includes a first switch transistor 1031, a second switch transistor 1032, and a first inductance 1033. The first positive output terminal 1011 of the first battery cell 101 is connected to the second negative output terminal 1022 of the second battery cell 102, the first negative output terminal 1012 of the first battery cell 101 is connected to a first terminal 10311 of the first switch transistor and the load negative terminal 1042 of the load, the second positive output terminal 1021 of the second battery cell 102 is connected to a second terminal 10322 of the second switch transistor and the load positive terminal 1041 of the load, an terminal of the first inductance 1033 is connected to the first positive output terminal 1011 and the second negative output terminal 1022, and another terminal of the first inductance 1033 is connected to a second terminal 10312 of the first switch transistor and a first terminal 10321 of the second switch transistor. In addition, an MOS transistor, an IGBT, and the like are generally selected as the first switch transistor 1031 and the second switch transistor 1032. Selection of the switch transistor is not limited in the present disclosure.

In this case, the work mode 1 is that based on a determination that the first preset condition is satisfied, the controller 105 controls on-duty cycles of the first switch transistor 1031 and the second switch transistor 1032, and controls a voltage difference between the second positive output terminal 1021 of the second battery cell and the second terminal 10322 of the second switch transistor to be within the first preset range, to cause only the first battery cell 101 to discharge to the load 104. In an embodiment, the first preset range is between 0.1 V and 1 V. The foregoing working principle is as follows. Based on a determination that the first switch transistor 1031 and the second switch transistor 1032 are turned on and off, by controlling a duty cycle, the first inductance 1033 stores a specified amount of charge, so that a voltage at the first terminal 10321 of the second switch transistor is a superimposed voltage of the first inductance 1033 and the first battery cell 101. Because the second switch transistor 1032 is turned on, a voltage at the second terminal 10322 of the second switch transistor is consistent with the voltage at the first terminal 10321 of the second switch transistor, and is also the superimposed voltage of the first inductance 1033 and the first battery cell 101. In addition, a voltage at the second positive output terminal 1021 of the second battery cell 102 is a sum of voltages of the second battery cell 102 and the first battery cell 101. Based on this, as long as it is ensured that the voltage at the second terminal 10322 of the second switch transistor is greater than the voltage at the second positive output terminal 1021 of the second battery cell 102, it may be ensured that the second battery cell 102 does not supply power, in other words, the superimposed voltage of the first inductance 1033 and the first battery cell 101 is greater than a superimposed voltage of the second battery cell 102 and the first battery cell 101. In addition, if a voltage difference between the superimposed voltage of the first inductance 1033 and the first battery cell 101 and the superimposed voltage of the second battery cell 102 and the first battery cell 101 is within the first preset range, because a difference between the two is not large, the first battery core is only discharged to the external and does not charge the second battery core.

In this case, the work mode 2 is that the controller 105 controls the first switch transistor 1031 and the second switch transistor 1032 to be turned off, to cause the first battery cell 101 and the second battery cell 102 to be connected in series and discharged together.

In this case, the work mode 3 is that the controller 105 controls on-duty cycles of the first switch transistor 1031 and the second switch transistor 1032, and controls a voltage difference between the second positive output terminal 1021 of the second battery cell and the second terminal 10322 of the second switch transistor to be within the second preset range, to cause the first battery cell 101 to charge the second battery cell 102 and to be discharged to the load 104. Furthermore, the second preset range is above 1 V. In addition, a working principle in the work mode 3 is the same as the foregoing working principle, as long as it is ensured that the voltage difference between the superimposed voltage of the first inductance 1033 and the first battery cell 101 and the superimposed voltage of the second battery cell 102 and the first battery cell 101 is within the second preset range. In this case, because the superimposed voltage of the first inductance 1033 and the first battery cell 101 is greater than the superimposed voltage of the second battery cell 102 and the first battery cell 101, the first battery cell 101 charges the second battery cell 102 and can be discharged to the external.

In the examples of the present disclosure, the power supply device includes multiple battery cells, and the same battery cells can be connected in series, in parallel, in parallel first and then in series, or in series first and then in parallel. A specific connection manner is not limited in the present disclosure. In addition, one battery cell may include multiple battery cores, and may have just one battery core. Based on a determination that the battery cell includes multiple battery cores, capacities of the battery cores located in a same group are approximately equal or the same, and chemical systems of the battery cores are consistent. For example, the battery cell includes six battery cores, a capacity of each battery core is 100 AH, and a chemical system of each battery core is lithium iron phosphate.

In an example of the present disclosure, one of the multiple battery cells is the first battery cell 101, and the rest of the multiple battery cells are the second battery cells 102. In addition, a ratio of a first parameter of a battery core of a battery cell in the first battery cell 101 to a first parameter of a battery core of any battery cell in the second battery cell 102 is to be greater than a preset threshold; and a ratio of a second parameter of the battery core of any battery cell in the second battery cell 102 to a second parameter of the battery core of the battery cell in the first battery cell 101 is to be greater than the preset threshold. In addition, a capacity of the battery core in the first battery cell 101 is to be greater than a sum of capacities of all battery cores in the second battery cell 102, to ensure a subsequent work mode.

In another example of the present disclosure, one of the multiple battery cells is the second battery cell 102, and the rest of the multiple battery cells are the first battery cells 101. In this example, a ratio of a first parameter of a battery core of each battery cell in the first battery cell 101 to a first parameter of a battery core of a battery cell in the second battery cell 102 is to be greater than a preset threshold; and a ratio of a second parameter of the battery core of battery cell in the second battery cell 102 to a second parameter of the battery core of each battery cell in the first battery cell 101 is to be greater than the preset threshold. In addition, a sum of capacities of all the battery cores in the first battery cell 101 is to be greater than a capacity of the battery core in the second battery cell 102, to ensure a subsequent work mode.

In another example of the present disclosure, some of the multiple battery cells are the first battery cells 101, and the rest of the multiple battery cells are the second battery cells 102. In this example, a ratio of a first parameter of a battery core of each battery cell in the first battery cell 101 to a first parameter of a battery core of each battery cell in the second battery cell 102 is to be greater than a preset threshold; and a ratio of a second parameter of a battery core in each battery cell in the second battery cell 102 to a second parameter of a battery core in each battery cell in the first battery cell 101 is to be greater than the preset threshold. In addition, a sum of capacities of all the battery cores in the first battery cell 101 is to be greater than a sum of capacities of all the battery cores in the second battery cell 102, to ensure a subsequent work mode.

In an example of the present disclosure, the first parameter is a capacity, and a ratio of a first capacity of the first battery cell 101 to a second capacity of the second battery cell 102 is greater than the preset threshold. The second parameter is a maximum rated pulse discharge rate, and a ratio of a maximum rated pulse discharge rate of the second battery cell 102 to a maximum rated pulse discharge rate of the first battery cell 101 is greater than the second preset threshold. The maximum rated pulse discharge rate is a maximum discharge rate causing a voltage of a battery to drop to a cut-off voltage within 10 s. Based on the foregoing parameter definition, the first battery cell 101 is an energy pack, and the second battery cell 102 is a power pack. In an embodiment, a capacity of the energy pack is greater than a capacity of the power pack, so that the vehicle mainly uses the energy pack for output. A maximum rated pulse discharge rate of the power pack is greater than a maximum rated pulse discharge rate of the energy pack, to ensure that normally based on a determination that large-power output is required, the power pack can be introduced to ensure high-power output of the vehicle.

In an embodiment of the present disclosure, based on a determination that a high SOC and a low power are satisfied, the power supply device enters the work mode 1, in other words, only the energy pack outputs. The first preset condition is that a required power of the load 104 is less than a power outputted by the first battery cell 101 at the maximum rated pulse discharge rate of the first battery cell. Under this condition, a required power of the vehicle is less than a discharge power of the first battery cell 101, and the first battery cell 101 can supply power to satisfy the normal demand of the vehicle. In an embodiment, the first preset condition may further be that under requirement of the foregoing power condition, the SOC of the first battery cell 101 is greater than the SOC of the second battery cell 102 and the SOC of the second battery cell 102 is less than the third preset threshold. In an embodiment, the first preset condition may further be that the SOC of the first battery cell 101 is greater than the SOC of the second battery cell 102 and the SOC of the second battery cell 102 is less than the third preset threshold. Under this condition, the SOC of the second battery cell 102 cannot satisfy an external output requirement, so that only the first battery cell 101 is configured to supply power. The third preset threshold is generally 30% SOC, optionally 20% SOC. However, because different users have different definition requirements for the SOC, the third preset threshold may be selected according to an actual case. This is not limited in the present disclosure.

In an example of the present disclosure, based on a determination that a high SOC and a high power are satisfied, the power supply device enters the work mode 2, in other words, the energy pack and the power pack are connected in series and supply power together. The second preset condition is that a required power of the load 104 is greater than a power outputted by the first battery cell 101 at the maximum rated pulse discharge rate of the first battery cell. Under this condition, because the required power of the vehicle is higher than an output power of the first battery cell 101, output of the first battery cell 101 alone cannot satisfy power demand of the vehicle. Based on this, the first battery cell 101 and the second battery cell 102 are configured to output together, to cause the second battery cell 102 to increase an overall output power of the power supply device, thereby satisfying high power demand of the vehicle. In some embodiments, the second preset condition may further be that the SOC of the first battery cell 101 and the SOC of the second battery cell 102 are greater than a fourth preset threshold. Under this condition, it can be ensured that the first battery cell 101 and the second battery cell 102 have enough energy to supply power, so that it can be ensured that the first battery cell 101 and the second battery cell 102 supply power together. The fourth preset threshold is generally 70% SOC, optionally 80% SOC. However, because different users have different definition requirements for the SOC, the fourth preset threshold may be selected according to an actual case. This is not limited in the present disclosure. In some embodiments, the SOC of the first battery cell 101 and the SOC of the second battery cell 102 are less than a fifth preset threshold. Under this condition, the first battery cell 101 and the second battery cell 102 cannot supply power alone, so that the first battery cell 101 and the second battery cell 102 are configured to output together. The fifth preset threshold is generally 30% SOC. However, because different users have different definition requirements for the SOC, the fifth preset threshold may be selected according to an actual case. This is not limited in the present disclosure.

In an example of the present disclosure, based on a determination that a difference between an SOC of the energy pack and an SOC of the power pack is too large, the work mode 3 is entered, in other words, the energy pack charges the power pack to achieve balance between the energy pack and the power pack. The third preset condition is that the SOC of the first battery cell 101 is greater than the SOC of the second battery cell 102, and a difference between the SOC of the first battery cell 101 and the SOC of the second battery cell 102 is greater than a sixth preset threshold. The sixth preset threshold is generally 30% SOC, optionally 50% SOC. However, because different users have different definition requirements for the SOC, the sixth preset threshold may be selected according to an actual case. This is not limited in the present disclosure.

Based on the foregoing examples, the power supply device includes the energy pack and the power pack, and based on the preset condition, the energy pack and the power pack are selected for coordinated output to satisfy requirements of endurance mileage and power, improve energy efficiency of the power supply device, and reduce costs of the power supply device.

The power supply device disclosed in the present disclosure may quickly achieve, by combining first battery cells and second battery cells with different quantities of strings without changing a battery core surface density, a compaction density, and an envelope size, an agile design of power supply devices required by different vehicles. In addition, based on this, an energy density of the power supply device can be further maximized, and a difference between different power supply devices can be greatly reduced, to achieve a standardized design of the power supply device and greatly reduce costs of the power supply device.

In addition, the terms “first” and “second” are used merely for the purpose of description, and shall not be construed as indicating or implying relative importance or implying a quantity of indicated technical features. Therefore, features defined by “first” and “second” may explicitly or implicitly include at least one of the features. In the descriptions of the present disclosure, unless otherwise specified, “multiple” means two or more than two, for example, two or three.

In the descriptions of this specification, a description of a reference term such as “an example”, “some examples”, “an illustration”, “a specific illustration”, or “some illustrations” means that a specific feature, structure, material, or characteristic that is described with reference to the example or the illustration is included in at least one example or illustration of the present disclosure. In this specification, exemplary description of the foregoing terms does not necessarily refer to a same example or illustration. Moreover, the specific features, structures, materials, or characteristics described may be combined in any one or more examples or illustrations in a suitable manner. In addition, different examples or illustrations described in this specification, as well as features of different examples or illustrations, may be integrated and combined by a person skilled in the art without contradicting each other.

Although the examples of the present invention are shown and described above, it may be understood that the foregoing examples are illustrative, and cannot be understood as limitations to the present invention. A person of ordinary skill in the art may make changes, modifications, replacements, and variations to the foregoing examples without departing from the scope of the present invention.

What is claimed is:

1. A power supply device, comprising a first battery cell and a second battery cell, wherein a first ratio of a first parameter of the first battery cell to a first parameter of the second battery cell is greater than a first threshold, a second ratio of a second parameter of the second battery cell to a second parameter of the first battery cell is greater than a second threshold, and the first threshold and the second threshold are greater than 1; and
in response to a determination that a first capacity of the first battery cell is greater than a second capacity of the second battery cell, the first battery cell and/or the second battery cell are/is discharged according to a rule, wherein the rule comprises a first condition, a second condition, and a third condition, wherein:
in response to a determination that the first condition is satisfied, the first battery cell is discharged to a load;
in response to a determination that the second condition is satisfied, the first battery cell and the second battery cell are discharged to the load; and
in response to a determination that the third condition is satisfied, the first battery cell is discharged to charge the second battery cell and discharged to the load.

2. The power supply device according to claim 1, wherein the first threshold and the second threshold are greater than or equal to 1.5.

3. The power supply device according to claim 1, wherein the first battery cell comprises at least one first battery core, and the second battery cell comprises at least one second battery core, wherein the at least one first battery core and the at least one second battery core satisfy |V1−V2|>0.1*V1 or |V1−V2|>0.1*V2,
wherein V1 is a voltage of the at least one first battery core, and V2 is a voltage of the at least one second battery core.

4. The power supply device according to claim 1, wherein the first battery cell comprises a plurality of first battery cores, the first battery cores are of a first chemical system, the second battery cell comprises a plurality of second battery cores, the second battery cores are of a second chemical system, and the first chemical system and the second chemical system are different.

5. The power supply device according to claim 4, wherein the first battery cell is a lithium iron phosphate battery, and the second battery cell is a lithium manganese oxide battery.

6. The power supply device according to claim 4, wherein the first battery cell is a lithium iron phosphate-graphite battery, and the second battery cell is a lithium metal battery.

7. The power supply device according to claim 1, further comprising: a control circuit, wherein the first battery cell and the second battery cell are connected to the control circuit; and a controller is connected to the control circuit and configured to control the first battery cell and the second battery cell to discharge according to the rule through the control circuit.

8. The power supply device according to claim 7, wherein the control circuit comprises a first switch transistor, a second switch transistor, and a first inductance,
wherein a first positive output terminal of the first battery cell is connected to a second negative output terminal of the second battery cell, a first negative output terminal of the first battery cell is connected to a first terminal of the first switch transistor and a load negative terminal of the load, a second positive output terminal of the second battery cell is connected to a second terminal of the second switch transistor and a load positive terminal of the load, a first terminal of the first inductance is connected to the first positive output terminal and the second negative output terminal, and a second terminal of the first inductance is connected to a second terminal of the first switch transistor and a first terminal of the second switch transistor.

9. The power supply device according to claim 8, wherein
in response to the determination that the first condition is satisfied, the first battery cell discharged to the load comprises: the controller controls on-duty cycles of the first switch transistor and the second switch transistor, and controls a voltage difference between the second positive output terminal of the second battery cell and the second terminal of the second switch transistor to be within a first range, for the first battery cell to discharge to the load;
in response to the determination that the second condition is satisfied, the first battery cell and the second battery cell discharged to the load comprises: the controller controls the first switch transistor and the second switch transistor to be turned off, for the first battery cell and the second battery cell to discharge to the load;
in response to the determination that the third condition is satisfied, the first battery cell discharged to charge the second battery cell and discharged to the load comprises: the controller controls on-duty cycles of the first switch transistor and the second switch transistor, and controls a voltage difference between the second positive output terminal of the second battery cell and the second terminal of the second switch transistor to be within a second range, for the first battery cell to discharge to charge the second battery cell and discharge to the load; and
a maximum value of the first range is less than a minimum value of the second range.

10. The power supply device according to claim 9, wherein the first range is 0.1 V to 1 V, and the second range is above 1 V.

11. The power supply device according to claim 1, wherein
the first parameter of the first battery cell and the first parameter of the second battery cell are respectively a capacity of the first battery cell and a capacity of the second battery cell; and
the second parameter of the first battery cell and the second parameter of the second battery cell are respectively a maximum rated pulse discharge rate of the first battery cell and a maximum rated pulse discharge rate of the second battery cell.

12. The power supply device according to claim 11, wherein
the first condition is that a required power of the load is less than a power outputted by the first battery cell at the maximum rated pulse discharge rate of the first battery cell, and/or a state of charge of the first battery cell is greater than a state of charge of the second battery cell and the state of charge of the second battery cell is less than a third threshold;
the second condition is that the required power of the load is greater than the power outputted by the first battery cell at the maximum rated pulse discharge rate of the first battery cell, and/or the state of charge of the first battery cell and the state of charge of the second battery cell are greater than a fourth threshold, and/or the state of charge of the first battery cell and the state of charge of the second battery cell are less than a fifth threshold; and
the third condition is that the state of charge of the first battery cell is greater than the state of charge of the second battery cell, and a difference between the state of charge of the first battery cell and the state of charge of the second battery cell is greater than a sixth threshold, wherein the maximum rated pulse discharge rate of the first battery cell is a maximum discharge rate causing a voltage of the first battery cell to drop to a cut-off voltage within 10 s, and the maximum rated pulse discharge rate of the second battery cell is a maximum discharge rate causing a voltage of the second battery cell to drop to the cut-off voltage within 10 s.

13. A vehicle, comprising a power supply device, wherein the power supply device comprises a first battery cell and a second battery cell,
a first ratio of a first parameter of the first battery cell to a first parameter of the second battery cell is greater than a first threshold, a second ratio of a second parameter of the second battery cell to a second parameter of the first battery cell is greater than a second threshold, and the first threshold and the second threshold are greater than 1, and
in response to a determination that a first capacity of the first battery cell is greater than a second capacity of the second battery cell, the first battery cell and/or the second battery cell are/is discharged according to a rule, wherein the rule comprises a first condition, a second condition, and a third condition, wherein:
in response to a determination that the first condition is satisfied, the first battery cell is discharged to a load;
in response to a determination that the second condition is satisfied, the first battery cell and the second battery cell are discharged to the load; and
in response to a determination that the third condition is satisfied, the first battery cell is discharged to charge the second battery cell and discharged to the load.

14. The vehicle according to claim 13, wherein the first threshold and the second threshold are greater than or equal to 1.5.

15. The vehicle according to claim 13, wherein the first battery cell comprises at least one first battery core, and the second battery cell comprises at least one second battery core, wherein the at least one first battery core and the at least one second battery core satisfy |V1−V2|>0.1*V1 or |V1−V2|>0.1*V2,
wherein V1 is a voltage of the at least one first battery core, and V2 is a voltage of the at least one second battery core.

16. The vehicle according to claim 13, wherein the first battery cell comprises a plurality of first battery cores, the first battery cores are of a first chemical system, the second battery cell comprises a plurality of second battery cores, the second battery cores are of a second chemical system, and the first chemical system and the second chemical system are different.

17. The vehicle according to claim 16, wherein the first battery cell is a lithium iron phosphate battery, and the second battery cell is a lithium manganese oxide battery.

18. The vehicle according to claim 16, wherein the first battery cell is a lithium iron phosphate-graphite battery, and the second battery cell is a lithium metal battery.

19. The vehicle according to claim 13, further comprising: a control circuit, wherein the first battery cell and the second battery cell are connected to the control circuit; and a controller is connected to the control circuit and configured to control the first battery cell and the second battery cell to discharge according to the rule through the control circuit.

20. The vehicle according to claim 19, wherein the control circuit comprises a first switch transistor, a second switch transistor, and a first inductance,
wherein a first positive output terminal of the first battery cell is connected to a second negative output terminal of the second battery cell, a first negative output terminal of the first battery cell is connected to a first terminal of the first switch transistor and a load negative terminal of the load, a second positive output terminal of the second battery cell is connected to a second terminal of the second switch transistor and a load positive terminal of the load, a first terminal of the first inductance is connected to the first positive output terminal and the second negative output terminal, and a second terminal of the first inductance is connected to a second terminal of the first switch transistor and a first terminal of the second switch transistor.
